(19) United States
(12) Patent Application Publication
(10) Pub. No.: US 2026/0348865 A1
(43) Pub. Date: Nov. 5, 2026

(54) TABLET IMAGE ACQUISITION DEVICE

(71) Applicant: BEIJING AOCHENG INTELLIGENCE TECHNOLOGY CO., LTD., Beijing (CN)

(72) Inventors: Jinghui ZHANG, Beijing (CN); Zhengxun HOU, Beijing (CN); Xiaoxiang WANG, Beijing (CN)

(73) Assignee: BEIJING AOCHENG INTELLIGENCE TECHNOLOGY CO., LTD., Beijing (CN)

(21) Appl. No.: 19/488,034

(22) PCT Filed: May 28, 2024
(86) PCT No.: PCT/CN2024/095757

§ 371 Date: Nov. 25, 2025

(30) Foreign Application Priority Data
May 26, 2023 (CN) 202310611503.1

(51) Int. Cl. G01N 21/88; G01N 21/95

(52) U.S. Cl. CPC G01N 21/8806; G01N 21/95

(57) ABSTRACT

A tablet image acquisition device includes a roller, the roller having a picking assembly on an outer side wall, a first station and a second station being arranged on a rotating path of roller, the picking assembly picking up a to-be-detected tablet at first station and conveying to a second station for release; a conveying assembly including a third station, configured to transfer the to-be-detected tablet from the second station the third station; a light reflecting assembly arranged on a periphery of the third station in a horizontal direction and configured to reflect a side surface image of the to-be-detected tablet; two shooting assemblies, respectively configured to shoot an outward surface of the to-be-detected tablet when passing through a shooting area, and shoot an upward surface of the to-be-detected tablet when passing through the third station and a side surface of the to-be-detected tablet reflected by the light reflecting assembly.

### CROSS-REFERENCE TO RELATED APPLICATIONS

This application is the National Stage of International Application No. PCT/CN2024/095757, filed on May 28, 2024, which claims priority to Chinese Patent Application No. 202310611503.1, filed on May 26, 2023. The disclosures of the above-mentioned applications are hereby incorporated by reference in their entireties.

### TECHNICAL FIELD

The present application relates to the field of tablet image acquisition, and specifically relates to a tablet image acquisition device.

### BACKGROUND

In the pharmaceutical field, especially for tablets, after production is completed, it is needed to detect to determine whether the to-be-detected tablets meet specifications before further packaging.

Currently, most tablet image acquisition devices use cameras to photograph front and back surfaces of the to-be-detected tablets, and then determine whether the to-be-detected tablets meet specifications based on the captured images. However, such acquisition devices can only acquire front surface and back surface images of the to-be-detected tablets and cannot capture side surface images of the to-be-detected tablets.

### SUMMARY

The present application provides a tablet image acquisition device, aiming to solve the problem that an existing tablet image acquisition device cannot acquire a side surface image of a tablet.

In the embodiment of the present application, the tablet image acquisition device includes:
a blanking device including a roller, a picking assembly being arranged on an outer side wall of the roller, a first station and a second station being arranged on a rotating path of the roller, the second station being located on a lower half arc of the rotating path of the roller, and the picking assembly being configured to pick up a to-be-detected tablet at the first station and release at the second station;
a conveying assembly which is arranged below the second station, includes a third station and is configured to receive the to-be-detected tablet released at the second station by the picking assembly and convey the to-be-detected tablet to the third station;
a first shooting assembly which is arranged on the rotating path of the to-be-detected tablet and faces the rotating path, and is configured to shoot an outward surface of the to-be-detected tablet when passing through the first shooting assembly;
a light reflecting assembly configured to reflect a side surface of the to-be-detected tablet; and
a second shooting assembly which is arranged above the third station in a vertical direction and faces the third station, and is configured to shoot an upward surface of the to-be-detected tablet when passing through the third station and a side surface of the to-be-detected tablet reflected by the light reflecting assembly.

In the embodiment of the present application, the picking assembly includes a plurality of clamping members, and the clamping members are configured to clamp the to-be-detected tablet at the first station and release the to-be-detected tablet at the second station.

In the embodiment of the present application, the picking assembly includes a plurality of adsorption holes, and the adsorption holes are configured to adsorb the to-be-detected tablet at the first station and release the to-be-detected tablet at the second station.

In the embodiment of the present application, the first shooting assembly faces an axis of the roller in a horizontal direction.

In the embodiment of the present application, the light reflecting assembly includes at least two reflectors which are arranged on a periphery of the third station.

In the embodiment of the present application, the light reflecting assembly includes a first reflector, a second reflector, a third reflector, and a fourth reflector;
in a conveying direction of the conveying assembly, the first reflector and the second reflector are correspondingly arranged on a left side and a right side of the third station and face the third station; and
in the conveying direction of the conveying assembly, the third reflector and the fourth reflector are correspondingly arranged on a front side and a rear side of the third station and face the third station.

In the embodiment of the present application, the first reflector and the second reflector are arranged at an included angle of 60°-80° with a horizontal plane; and the third reflector and the fourth reflector are arranged at an included angle of 40°-60° with the horizontal plane.

In the embodiment of the present application, the first reflector and the second reflector are arranged at an included angle of 65°-75° with the horizontal plane; and the third reflector and the fourth reflector are arranged at an included angle of 45°-55° with the horizontal plane.

In the embodiment of the present application, the first shooting assembly further includes a first light source which faces a shooting area of the first shooting assembly; and the second shooting assembly further includes a second light source which faces the third station.

In the embodiment of the present application, the tablet image acquisition device further includes a control part which is connected to the first shooting assembly and the second shooting assembly;
a sensor is arranged at the third station, is connected to the control part, and configured to detect whether the to-be-detected tablet is at the third station; and
the control part is configured to control the first shooting assembly to shoot, and control the second shooting assembly to shoot based on a detection signal of the sensor.

In the embodiment of the present application, the tablet image acquisition device further includes a display part; and the display part is connected to the first shooting assembly and the second shooting assembly, and is configured to display images shot by the first shooting assembly and the second shooting assembly.

In the embodiment of the present application, a mounting cavity is formed in the roller, and the adsorption holes are in communication with the mounting cavity;
a wind shield is arranged in the mounting cavity and is provided with a first area and a second area; the first area is provided with a blowing hole, and the second area is configured to shield wind; the blowing hole faces the second station; on the rotating path of the roller, the adsorption holes sequentially pass through the blowing hole in the first area and the second area;
the tablet image acquisition device further includes a first air source assembly and a second air source assembly; the first air source assembly is configured to drive air in the roller to move to make an air pressure in the roller less than an external air pressure; and the second air source assembly is configured to blow air from the blowing hole in the wind shield to the adsorption holes passing through the blowing hole.

In the embodiment of the present application, the wind shield is arc-shaped and is coaxial with the roller; and a difference between an inner diameter of the roller and a diameter of an arc with an outer surface of the wind shield is 0.1 mm-10 mm.

In the embodiment of the present application, the wind shield is arc-shaped and is coaxial with the roller; and the difference between the inner diameter of the roller and the diameter of the arc with the outer surface of the wind shield is 0.1 mm-3 mm.

In the embodiment of the present application, the ends of the adsorption holes close to the mounting cavity are conical holes, and the ends of the adsorption holes close to the outer side of the roller are stripy holes; the conical holes are in communication with the stripy holes; and calibers of the ends of the conical holes close to the outer side are smaller than the calibers of the ends of the conical holes close to the inner side.

In the embodiment of the present application, after the to-be-detected tablet is picked up from the first station by the picking assembly and before the to-be-detected tablet is conveyed to the second station, the image of the surface facing the outer side can be shot by the first shooting assembly; and after being conveyed to the second station, the to-be-detected tablet is released to the conveying assembly, and at the moment, the surface originally facing the outer side on the picking assembly face downward and the surface originally facing the inner side on the picking assembly faces upward, so that after the to-be-detected tablet is continuously conveyed to the third station, the other surface of the to-be-detected tablet can be shot by the second shooting assembly. In addition, the light reflection assembly is further arranged on the periphery of the third station and the second shooting assembly can shoot the side surface of the to-be-detected tablet through the light reflection assembly, so the tablet image acquisition device can acquire the images of the front surface, the back surface, and the side surface of the tablet, thereby obtaining a complete image of each surface of the tablet.

### BRIEF DESCRIPTION OF THE DRAWINGS

In order to more clearly illustrate the technical solutions in the embodiments of the present application or the prior art, the accompanying drawings needed in the description of the embodiments or the prior art will be briefly introduced below. Obviously, the accompanying drawings described below are only some embodiments of the present application. For those of ordinary skill in the art, other accompanying drawings can also be obtained based on the structures shown in these accompanying drawings without involving any inventive effort.

FIG. 1 is a schematic structural diagram of a tablet image acquisition device in an embodiment of the present application;

FIG. 2 is a top view of a tablet image acquisition device in an embodiment of the present application;

FIG. 3 is a structure schematic diagram of a roller of a tablet image acquisition device in an embodiment of the present application;

FIG. 4 is a section view of a roller of a tablet image acquisition device in an embodiment of the present application;

FIG. 5 is a schematic structural diagram of a third station of a conveying assembly of a tablet image acquisition device in an embodiment of the present application;

FIG. 6 is a schematic structural diagram of a wind shield of a tablet image acquisition device in an embodiment of the present application; and

FIG. 7 is a section view of an adsorption hole of a tablet image acquisition device in an embodiment of the present application.

Reference numerals: 100—blanking device; 110—roller; 111—mounting cavity; 112—adsorption hole; 113—stripy hole; 114—concial hole; 115—first station; 116—second station; 120—wind shield; 121—first area; 122—blowing hole; 123—second area; 130—second air source assembly; 200—conveying assembly; 210—third station; 300—first shooting assembly; 310—first light source; 400—second shooting assembly; 410—second light source; 500—light reflecting assembly; 510—first reflector; 520—second reflector; 530—third reflector; and 540—fourth reflector.

The achievement of an objective, functional characteristics, and advantages of the present application will be further illustrated with reference to the embodiments and accompanying drawings.

### DETAILED DESCRIPTION OF THE EMBODIMENTS

The technical solutions of the embodiments of the present application will be clearly and completely described in conjunction with the accompanying drawings in the embodiments of the present application. Obviously, the described embodiments are only a part of the embodiments of the present application, not all of them. Based on the embodiments of the present application, any other embodiments obtained by those skilled in the art without creative efforts also fall within the scope of protection of the present application.

It is to be noted that if the embodiments of the present application involve directional indications (such as up, down, left, right, front, and back), these directional indications are only used for describing relative positional relationships and movements between components in a specific posture (as shown in the accompanying drawings). If the specific posture changes, the directional indications will correspondingly change as well.

In addition, if the embodiments of the present application involve descriptions such as “first” and “second”, such descriptions of “first” and “second” are only for descriptive purposes and should not be understood as indicating or implying relative importance or implicitly specifying the quantity of the technical features indicated. Therefore, features limited by “first” and “second” can explicitly or implicitly include at least one of the respective features. Moreover, the technical solutions of various embodiments can be combined with each other, but it must be based on that a person of ordinary skill in the art can achieve. When the combination of technical solutions results in mutual contradictions or is not feasible, such a combination of technical solutions should be considered non-existent and is not within the scope of protection claimed in the present application.

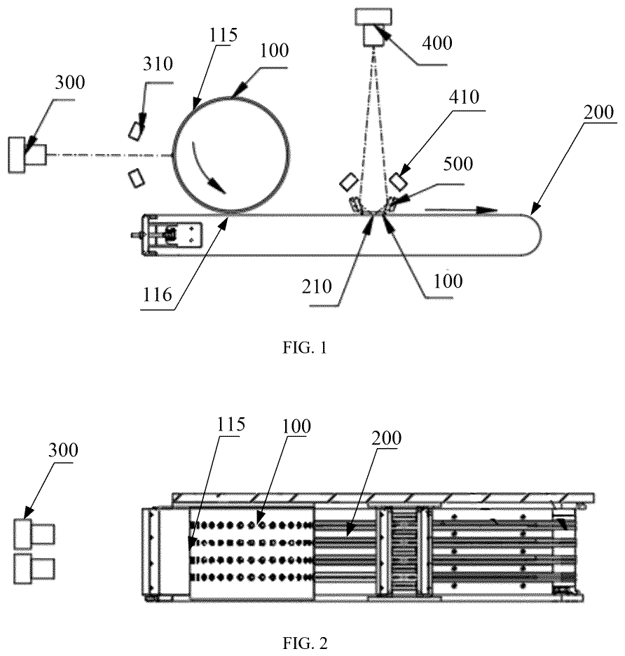

As shown in FIG. 1 and FIG. 2, in the embodiment of the present application, the tablet image acquisition device includes:
a blanking device 100 including a roller 110, a picking assembly being arranged on an outer side wall of the roller 110, a first station 115 and a second station 116 being arranged on a rotating path of the roller 110, the second station 116 being located on a lower half arc of the rotating path of the roller 110, and the picking assembly being configured to pick up to-be-detected tablets at the first station 115 and conveying the to-be-detected tablets to the second station 116 for release;
a conveying assembly 200 which is arranged below the second station 116, includes third stations 210 and is configured to receive the to-be-detected tablets released at the second station 116 by the picking assembly and convey the to-be-detected tablets to the third stations 210;
first shooting assemblies 300 which are arranged on the rotating path of the to-be-detected tablets and face the rotating path, and are configured to shoot outward surfaces of the to-be-detected tablets when passing through the first shooting assemblies 300;
light reflecting assemblies 500 configured to reflect side surface images of the to-be-detected tablets; and
second shooting assemblies 400 which are arranged above the third stations 210 in a vertical direction and face the third stations 210, and are configured to shoot upward surfaces of the to-be-detected tablets when passing through the third stations 210 and side surfaces of the to-be-detected tablets reflected by the light reflecting assemblies 500.

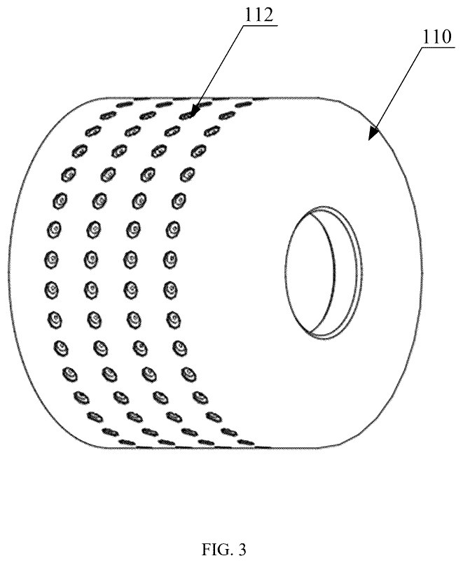

As shown in FIG. 3, the roller 110 is approximately cylindrical, and the picking assembly on the outer side wall of the roller 110 can be in various forms, for example, in the embodiment of the present application, the picking assembly can include a plurality of clamping members which can be similar to devices such as clamps and manipulators, and the plurality of clamping members are arranged on the outer side wall of the roller 110; and each clamping member can be driven by an air cylinder to perform actions of clamping and releasing.

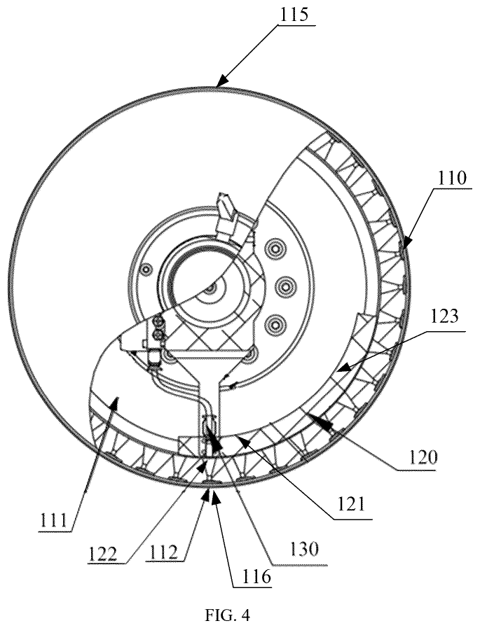

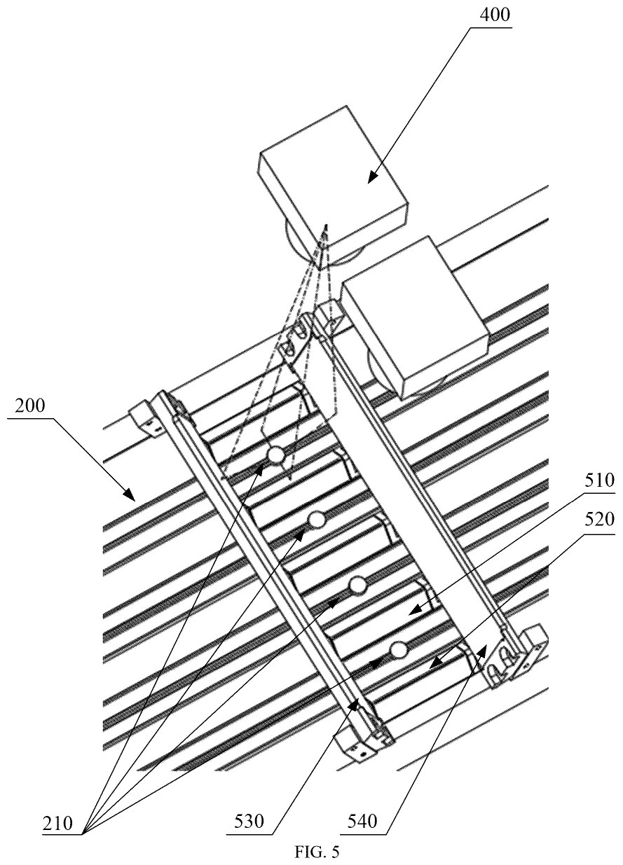

In addition, in other embodiments, the picking assembly can also be a plurality of adsorption holes 112; and taking the picking assembly being the plurality of adsorption holes 112 as an example, as shown in FIG. 3 and FIG. 4, the interior of the roller 110 is hollowed out to form a mounting cavity 111, the plurality of adsorption holes 112 are formed in a side wall of the roller 110, and each adsorption hole 112 is in communication with the mounting cavity 111 inside the roller. The plurality of adsorption holes 112 are arranged in an axial direction and a circumferential direction of the roller 110, for example, a plurality of rows of adsorption holes 112 are formed in the circumferential direction of the roller 110, and each row of adsorption holes 112 are arranged in the axial direction of the roller 110. As shown in FIG. 3, in the embodiment of the present application, each row of adsorption holes 112 arranged in the circumferential direction of the roller 110 include four adsorption holes 112. It is to be noted that the number of rows of adsorption holes 112 arranged in the circumferential direction of the roller 110 and the number of adsorption holes 112 arranged in each row are not limited in the embodiment of the present application. In addition, if the picking assembly is the clamping members, the clamping members can also be arranged on the outer side wall of the roller in the same arrangement mode as the adsorption holes 112.

As shown in FIG. 1 and FIG. 4, if the roller 110 rotates anticlockwise around own axis, the adsorption holes 112 in the side wall of the roller 110 are configured to adsorb the to-be-detected tablets; and after being adsorbed on the adsorption holes 112, as the roller 110 rotates, the to-be-detected tablets can be released at a specified position.

As shown in FIG. 1, in the embodiment of the present application, the first station 115 can be arranged right above the roller 11, and the first station 115 can be a feeding station; the to-be-detected tablets are conveyed to the outer side wall of the roller 110 from the first station 115; when the to-be-detected tablets are close to the outer side wall of the roller 110, the adsorption holes 112 pass through the first station 115, and the to-be-detected tablets can be adsorbed into the adsorption holes 112 through an adsorption force generated by the adsorption holes 112.

After adsorbing the to-be-detected tablets, as the roller 110 rotates, the adsorption holes 112 can convey the to-be-detected tablets to the second station 116, in which, the second station 116 is located on the lower half arc of the rotating path of the roller 110, thus when the adsorption holes 112 release the to-be-detected tablets, the sides of the to-be-detected tablets originally facing the inner sides of the adsorption holes 112 can be turned to be the sides facing upward. In addition, in one embodiment, the second station 116 can be located at the bottom of the rotating path of the roller 110; when being conveyed to the second station 116 by the adsorption holes 112, the to-be-detected tablets are released by the adsorption holes 112, at the moment, the to-be-detected tablets can fall onto the conveying assembly 200 at the minimum falling height, and the conveying assembly 200 receives the to-be-detected tablets and continuously conveys the to-be-detected tablets.

With reference to FIG. 1 and FIG. 2, after being adsorbed by the adsorption holes 112 at the first station 115 and before being conveyed to the second station 116 as the roller 110 rotates, the to-be-detected tablets will pass through the first shooting assemblies 300. As shown in FIG. 1, the first shooting assemblies 300 can be webcams, cameras, or other image acquisition devices; as the first shooting assemblies 300 are arranged between the first station 115 and the second station 116 in the rotating direction of the roller 110, each to-be-detected tablet is adsorbed by the adsorption holes 112 from the first station 115 to the second station 116 to be released, and the to-be-detected tablet will certainly pass through the first shooting assemblies 300 during the shooting period, so that the first shooting assemblies 300 can shoot the to-be-detected tablet in the each adsorption hole 112 in the meanwhile.

Generally, round tablets or square tablets mostly include front surfaces, back surfaces, and side surfaces. If the to-be-detected tablets are adsorbed at the first station 115 by adsorption holes 112, with the front surfaces facing outward and the back surfaces facing inward, the front surfaces of the to-be-detected tablets always face outward during being conveyed between the first station 115 and the second station 116, and thus the first shooting assemblies 300 can shoot the front surfaces of the to-be-detected tablets.

It is to be noted, as shown in FIG. 3, in the embodiment of the present application, each row of adsorption holes 112 arranged in the axial direction of the roller 110 can include four adsorption holes 112, namely, when the roller 110 rotates to shooting areas of the first shooting assemblies 300, four to-be-detected tablets face the first shooting assemblies 300, and at the moment, the first shooting assemblies 300 can include one camera which is configured to simultaneously shoot the front surface images of the four to-be-detected tablets. Certainly, in other embodiments, the first shooting assemblies 300 can also include four cameras which are configured to correspondingly shoot the front surfaces of the four to-be-detected tablets.

As shown in FIG. 1 and FIG. 2, the conveying assembly 200 can be a conveying belt, and the conveying assembly 200 is arranged below the roller 110 and passes through the second station 116, so that the to-be-detected tablets can fall onto the conveying assembly 200 after being released by the adsorption holes 112 at the second station 116. During mounting, the conveying assembly 200 can be close to the roller 110 as much as possible on the premise of ensuring that the to-be-detected tablets can run on the conveying belt without being interfered by the roller 110, and thus the to-be-detected tablets can be prevented from randomly rolling after falling from the adsorption holes 112. If the to-be-detected tablets are adsorbed in the adsorption holes 112, with the front surfaces facing outward and the back surfaces facing inward, the front surfaces of the to-be-detected tablets will face downward when the to-be-detected tablets are conveyed to the second station 116 by the roller 110, and after the to-be-detected tablets fall onto the conveying assembly 200, the front surfaces will face upwards and the back surfaces will face downwards, thus the back surfaces of the to-be-detected tablets can be shot after being continuously conveyed to the third stations 210.

As shown in FIG. 1, the second shooting assemblies 400 are arranged right above the third stations 210, similarly, the second shooting assemblies 400 can be the webcams, the cameras, or other image acquisition devices; and taking the second shooting assemblies 400 being the webcam for example, the webcams vertically downwards faces the third stations 210, so that the second shooting assemblies 400 can shoot the back surfaces of the to-be-detected tablets after the to-be-detected tablets are conveyed to the third stations 210 by the conveying belt.

As shown in FIG. 3 and FIG. 5, each row of adsorption holes 112 arranged in the axial direction of the roller 110 include four adsorption holes 112, namely, after the roller 110 rotates to reach the second station 116, four tablets will fall onto the conveying assembly 200, thus there will be four third stations 210 on the conveying assembly 200, and the four tablets correspondingly pass through one third station 210. At the moment, for the second shooting assemblies 400, the back surface images of the four to-be-detected tablets on the four third stations 210 can be shot at the same time by one camera. Certainly, in other embodiments, the second shooting assemblies 400 can also include four cameras for correspondingly shooting the back surfaces of the four to-be-detected tablets.

With reference to FIG. 5, taking the four third stations 210 on the conveying assembly 200 for example, each third station 210 is provided with one light reflecting assembly 500. The light reflecting assemblies 500 can include a plurality of reflectors which can be slightly higher than the third stations 210 so as to ensure that the to-be-detected tablets can normally pass through lower portions of the reflectors, and the side surface images of the to-be-detected tablets are reflected into the second shooting assemblies 400 by the plurality of reflectors, thereby acquiring the side surface images of the to-be-detected tablets. In addition, in the embodiment of the present application, the number of the reflectors is not limited, as long as all the side surface images of the to-be-detected tablets can be reflected.

In the embodiment of the present application, after the to-be-detected tablets are picked up from the first station 115 by the picking assembly (the adsorption holes 112 or the clamping assembly) and before the to-be-detected tablets are conveyed to the second station 116, the images of the surfaces facing the outer side can be shot by the first shooting assemblies 300; after being conveyed to the second station 116, the to-be-detected tablets are released onto the conveying assembly 200, at the moment, the surfaces originally facing the outer side on the clamping assembly face downward and the surfaces originally facing the inner side on the clamping assembly face upward, so that after the to-be-detected tablets are continuously conveyed to the third stations 210, the other surfaces of the to-be-detected tablets can be shot by the second shooting assemblies 400. In addition, the light reflecting assemblies 500 are further arranged on the peripheries of the third stations 210; and the second shooting assemblies 400 can be configured to shoot the side surfaces of the to-be-detected tablets through the light reflecting assemblies 500, and therefore, the tablet image acquisition device can be acquire all images of the front surfaces, the back surfaces and the side surfaces of the to-be-detected tablets.

As shown in FIG. 1, in the embodiment of the present application, the first shooting assemblies 300 face an axis of the roller 110 in the horizontal direction. As shown in FIG. 1, the first shooting assemblies 300 are as high as the axis of the roller 110, and the first shooting assemblies 300 horizontally face the roller 110 from the left side of the roller 110; and the adsorption holes 112 in the outer side wall of the roller 110 are in a vertical status when facing the first shooting assemblies 300, which facilitates the first shooting assemblies 300 to shoot a clear image.

In the embodiment of the present application, the light reflecting assemblies 500 include at least two reflectors which are arranged on the periphery of the third station.

For example, in the embodiment of the present application, the light reflecting assemblies 500 can include four reflectors: first reflectors 510, second reflectors 520, a third reflector 530, and a fourth reflector 540.

Specifically, in the conveying direction of the conveying assembly 200, the first reflectors 510 and the second reflectors 520 are correspondingly arranged on the left side and the right side of the third stations 210 respectively and face the third stations 210, as shown in FIG. 5, the first reflectors 510 and the second reflectors 520 on each third station 210 correspondingly reflect the images of the left side surfaces and the right side surfaces of the to-be-detected tablets in the conveying direction, and the first reflectors 510 and the second reflectors 520 reflect the images of the left side surfaces and the right side surfaces of the to-be-detected tablets in the conveying direction to the second shooting assemblies 400, so that the second shooting assemblies 400 can shoot the images of the left side surfaces and the right side surfaces of the to-be-detected tablets in the conveying direction.

In the conveying direction of the conveying assembly 200, the third reflector 530 and the fourth reflector 540 are correspondingly arranged on the front side and the rear side of the third stations 210 and face the third stations 210. As shown in FIG. 5, the third reflector 530 and the fourth reflector 540 on each third station 210 correspondingly reflect the images of the left side surfaces and the right side surfaces of the to-be-detected tablets in the direction shown in FIG. 5, and the third reflector 530 and the fourth reflector 540 correspondingly reflect the images of the front side surfaces and the rear side surfaces of the to-be-detected tablets in the conveying direction to the second shooting assemblies 400, so that the second shooting assemblies 400 can shoot the images of the front side surfaces and the rear side surfaces of the to-be-detected tablets in the conveying direction.

In addition, as shown in FIG. 5, the first reflectors 510 on the four third stations 210 can be integrally arranged, that is, one first reflector 510 is arranged to cross the four third stations 210, similarly, the second reflectors 520 on the four third stations 210 can also be integrally arranged, namely, one second reflector 520 is arranged to cross the four third stations 210, thus, the number of the first reflectors 510 and the number of the second reflectors 520 can be reduced, and mounting is convenient.

The to-be-detected tablets are shown in FIG. 5; in the embodiment of the present application, the first reflectors 510 and the second reflectors 520 are arranged an included angle of 60°-80° with the horizontal plane, preferably 65°-75°. The third reflector 530 and the fourth reflector 540 are arranged at an included angle of 40°-60° with the horizontal plane, preferably 45°-55°. The first reflectors 510, the second reflectors 520, the third reflector 530, and the fourth reflector 540 are arranged according to the above angles, thus the side surface images of the to-be-detected tablets can be reflected to the second shooting assemblies 400 conveniently, and the reflected images are clear.

For another example, in another embodiment, the light reflecting assemblies 500 include two reflectors, namely a fifth reflector and a sixth reflector; in the conveying direction of the conveying assembly, the fifth reflector and the sixth reflector are correspondingly arranged on two sides of the third station, and face the third station; or in the conveying direction of the conveying assembly, the fifth reflector and the sixth reflector are correspondingly arranged on the front and back sides of the third station, and face the third station. When four reflectors are arranged, the side surface images of half circumferences of the to-be-detected tablets can be reflected in the direction to which each reflector is arranged, namely the images reflected by the four reflectors have overlapped parts, therefore, an unclear position of the edge of the image reflected by each reflector can be judged based on the images reflected by other reflectors. The difference between arranging two reflectors and arranging four reflectors is that when two reflectors are arranged, each reflector can reflect the side surface images of the half circumferences of the to-be-detected tablets, and there are no overlapped areas, so that there may be an unclear condition in the edge area reflected by each reflector when two reflectors are arranged.

For yet another example, in another embodiment, the light reflecting assemblies 500 can further include three reflectors: a seventh reflector, an eighth reflector, and a ninth reflector, in which, the seventh reflector, the eighth reflector, and the ninth reflector are uniformly arranged at intervals on the periphery of the third station in the horizontal direction. When three reflectors are arranged, the area reflected by each reflector has an overlapped part, so that the position with unclear edge can be judged based on the images reflected by other reflectors.

As shown in FIG. 1, in the embodiment of the present application, the first shooting assemblies 300 further include first light sources 310 which face the shooting areas of the first shooting assemblies 300; and the second shooting assemblies 400 further include second light sources 410 which face the third stations 210. The first light sources 310 and the second light sources 410 can both be stripy light sources, the first light sources 310 are arranged between the first shooting assemblies 300 and the roller 110, and the second light sources 410 are arranged between the second shooting assemblies 400 and the third stations 210. By the first light sources 310 and the second light sources 410, the first shooting assemblies 300 and the second shooting assemblies 400 can shoot clear images of the to-be-detected tablets conveniently.

In the embodiment of the present application, the tablet image acquisition device further includes a control part which is connected to the first shooting assemblies 300 and the second shooting assemblies 400; the third stations 210 are provided with sensors, and the sensors are connected to the control part and configured to detect whether the to-be-detected tablets are at the third stations 210; and the control part is configured to control the first shooting assemblies 300 to shoot and control the second shooting assemblies 400 to shoot based on a detection signal of the sensor.

The roller 110 is generally driven by a servo motor; the rotating speed of the roller 110 can be obtained according to the rotating speed of the servo motor; and the time for the adsorption holes 112 to rotate from the first station 115 to the first shooting assemblies 300 and a time interval for two adjacent rows of adsorption holes 112 to pass through the first shooting assemblies 300 can be calculated based on the diameter of the roller 110 and the angle between the two adjacent rows of adsorption holes 112, and therefore, the first shooting assemblies 300 can be controlled to shoot through the control part according to the time interval.

In addition, the sensor can be an infrared sensor, and a detection route of the infrared sensor penetrates through the conveying route of the to-be-detected tablets on the third stations 210, so that when the to-be-detected tablets pass through the third stations 210, the infrared sensor can detect the to-be-detected tablets; and when the infrared sensor detects that the to-be-detected tablets pass through the third stations 210, a signal will be transmitted to the control part, and the control part will control the second shooting assemblies 400 to shoot.

In the embodiment of the present application, the tablet image acquisition device further includes a display part, and the display part is connected to the first shooting assemblies 300 and the second shooting assemblies 400 and is configured to display the images shot by the first shooting assemblies 300 and the second shooting assemblies 400. By the display part, the images shot by the first shooting assemblies 300 and the second shooting assemblies 400 can be displayed, which facilitates workers to observe the images.

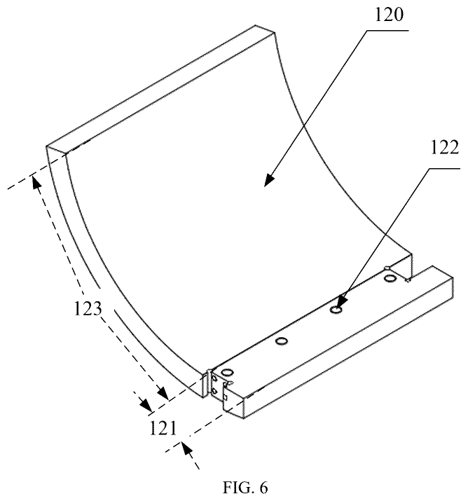

As shown in FIG. 4 and FIG. 6, in the embodiment of the present application, when the picking assembly is the adsorption holes 112, a mounting cavity 111 is formed in the roller 110 and is in communication with the adsorption holes 112; a wind shield 120 is arranged in the mounting cavity 111 and is provided with a first area 121 and a second area 123, the first area 121 is provided with blowing holes 122, and the second area 123 is configured to shield wind; the blowing holes 122 face the second station 116; on the rotating path of the roller 110, the adsorption holes 112 pass through the blowing holes 122 in the first area 121 and the second area 123 in sequence; the tablet image acquisition device further includes a first air source assembly and a second air source assembly 130, the first air source assembly is configured to drive the air in the roller 110 to move to make an internal air pressure of the roller 110 less than an external air pressure; and the second air source assembly 130 is configured to blow air from the blowing holes 122 in the wind shield 120 to the adsorption holes 112 passing through the blowing holes 122.

The wind shield 120 is located in the mounting cavity 111 of the roller 110, and the wind shield 120 can be of an arc-shaped plate-shaped structure and includes the first area 121 and the second area 12; the first area 121 is provided with the blowing holes 122 which penetrate through the wind shield 120 in a thickness direction of the wind shield 120, the number of the blowing holes 122 is the same as that of the adsorption holes 112 in each row in the side wall of the roller 110, for example, four adsorption holes 112 are formed in each row in the side wall of the roller 110, and four blowing holes 122 can be formed in the wind shield 120; the four blowing holes 122 are located in the same straight line, and the distance between the blowing holes 122 is the same as that between the four adsorption holes 112 in each row in the side wall of the roller 110; and the second area 123 is of a solid structure that can play a role in blocking air flow.

In addition, the mounting position of the wind shield 120 meets the following conditions: on the rotation path of the roller 110, after adsorbing materials, the adsorption holes 112 firstly pass through the blowing holes 122 in the first area 121 and then pass through the second area 123. As shown in FIG. 1, FIG. 4, and FIG. 6, the roller 110 rotates anticlockwise, the wind shield 120 is fixed inside the roller 110, the first area 121 is on the left side and faces the second station 116, the second area 123 is on the right side, and at the moment, the first station 115 can be arranged at any position allowing clockwise rotating between the first area 121 and the second area 123, so that after each row of adsorption holes 112 on the roller 110 adsorb the to-be-detected tablet, the adsorption holes 112 pass through the first area 121 and then pass through the second area 123; and when passing through the first area 121, the four adsorption holes 112 in each row are respectively aligned with the four blowing holes 122 in the wind shield 120 and face the second station 116.

The first air source assembly is configured to pump air from inside to the outside of the roller 110; when the air in the roller 110 is pumped, the internal air pressure of the roller 110 is less than the external air pressure, thus a negative pressure is formed in the roller 110, and the adsorption holes 112 in the outer side wall of the roller 110 will generate the adsorption force towards the inside of the roller 110; and the second air source assembly 130 is configured to blow air from the blowing holes 122 in the wind shield 120 to the adsorption holes 112 passing through the blowing holes 122. As shown in FIG. 1, FIG. 2, and FIG. 4, in the operation process, the to-be-detected tablet are fed from the first station 115, the roller 110 rotates anticlockwise, the first air source assembly pumps air from the inside of the roller 110 to the outside, thus the negative pressure is formed in the roller 110; and after the adsorption holes 112 in the side wall of the roller 110 rotate to reach the first station 115, the to-be-detected tablets on the first station 115 can be adsorbed in the adsorption holes 112; as the roller 110 continuously rotates, the to-be-detected tablets on the first station 115 can be adsorbed one by one into the adsorption holes 112 in the side wall of the roller 110; when the adsorption holes 112 move to the second station 116, namely the first area 121 of the wind shield 120, the adsorption holes 112 are aligned with the air blowing holes 122, the second air source assembly 130 starts to blow air, at the moment, the four air blowing holes 122 are aligned with the four adsorption holes 112 in the same row, and therefore the second air source assembly 130 can blow off the to-be-detected tablets on the row of adsorption holes 112 that are aligned with the air blowing holes 122 at the moment, and the four tablets are arranged in a row; as the roller 110 continuously rotates, the adsorption holes 112 with the to-be-detected tablets released rotate to the second area 123, the second area 123 of the wind shield 120 is of the solid structure and can block air flow, and therefore the adsorption force generated by the first air source assembly to the adsorption holes 112 with the to-be-detected tablets released can be blocked to a certain degree, and the blown-off to-be-detected tablets can be prevented from entering the adsorption holes 112 for the second time. As the roller 110 rotates, the to-be-detected tablets in the adsorption holes 112 in the outer side wall of the roller 110 are blown off when passing through the first area 121 and are arranged on the conveying assembly 200, with four in one row; after releasing the to-be-detected tablets, the adsorption holes 112 immediately rotate to the corresponding position at the second area 123, the second area 123 is of a non-ventilation structure, and therefore the blown-off to-be-detected tablets can be prevented from being adsorbed by the adsorption holes 112 without the to-be-detected tablets for the second time.

As shown in FIG. 4 and FIG. 6, in the embodiment of the present application, the wind shield 120 is arc-shaped and is coaxial with the roller 110, and the difference between the inner diameter of the roller 110 and the diameter of an arc with the outer surface of the wind shield 120 is 0.1 mm-10 mm. The wind shield 120 is of an arc-shaped plate structure and is coaxially mounted with the roller 110, and the difference between the inner diameter of the roller 110 and the diameter of the arc with the outer surface of the wind shield 120 is 0.1 mm-10 mm, preferably 0.1 mm-3 mm, that is, a gap between the inner wall of the roller 110 and the outer wall of the wind shield 120 is preferably 0.1 mm-3 mm, the wind shield 120 is close to the inner wall of the roller 110 as much as possible, thus the wind shield 120 can provide a relatively good wind blocking effect for the covered inner wall area of the roller 11, and the blown-off materials are prevented from being adsorbed by the adsorption holes 112 in the position covered by the second area 123 of the wind shield 120 for the second time.

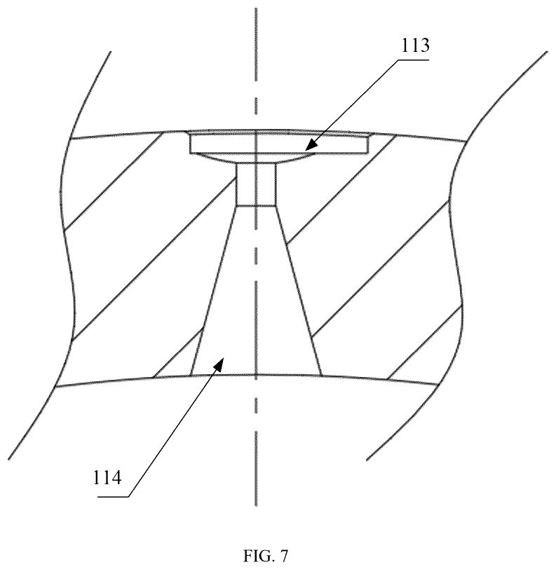

As shown in FIG. 7, in the embodiment of the present application, the ends of the adsorption holes 112 close to the mounting cavity 111 are conical holes 114, and the ends of the adsorption holes 112 close to the outer side of the roller 110 are stripy holes 113; the conical holes 114 are in communication with the stripy holes 113; and calibers of the ends of the conical holes 114 close to the outer side are smaller than the calibers of the ends of the conical holes close to the inner side.

The adsorption holes 112 are close to the conical holes 114 in the inner side of the mounting cavity 111, and the calibers of the ends of the conical holes 112 close to the outer side are smaller than the calibers of the ends of the conical holes 112 close to the inner side, so that when the first air source assembly pumps air, the adsorption holes 112 can generate large adsorption force, and meanwhile, when the second air source assembly 130 blows air from inside to outside, the to-be-detected tablets are easy to blow off. In addition, in other embodiments, the calibers of the conical holes 114 can gradually decrease from inside to outside. In addition, the parts of the adsorption holes 112 close to the outer side of the roller 110 is sunken inwards from the outer side wall of the roller 110 to form the stripy holes 113, thus the to-be-detected tablets are conveniently adsorbed, the to-be-detected tablets are kept in a good adsorption posture in the adsorption holes 112, and the reliability of adsorbing the to-be-detected tablets is guaranteed.

In the embodiment of the present application, after the to-be-detected tablets are picked up by the picking assembly at the first station 115, and before the to-be-detected tablets are conveyed to the second station 116, the images of the surfaces facing the outer side can be shot by the first shooting assemblies 300; after being conveyed to the second station 116, the to-be-detected tablets are released onto the conveying assembly 200, at the moment, the surfaces originally facing the outer side on the picking assembly face downward, and the surfaces originally facing the inner side on the picking assembly face upward, so that after the to-be-detected tablets are continuously conveyed to the third stations 210, the other surfaces of the to-be-detected tablets can be shot by the second shooting assemblies 400. In addition, the light reflecting assemblies 500 are further arranged on the peripheries of the third stations 210, and the second shooting assemblies 400 can shoot the side surfaces of the to-be-detected tablets through the light reflecting assemblies 500, and therefore, the tablet image acquisition device can acquire all the images of the front surfaces, the back surfaces and the side surfaces of the to-be-detected tablets.

The above-described embodiments are merely optional embodiments of the present application and do not consequently limit the scope of the patent of the present application. Any equivalent structural changes made based on the content of this specification and accompanying drawings under the inventive concept of the present application, or any direct/indirect application in other related technical fields, are included within the scope of patent protection of the present application.

1. A tablet image acquisition device, comprising:
a blanking device comprising a roller, a picking assembly being arranged on an outer side wall of the roller, a first station and a second station being arranged on a rotating path of the roller, the second station being located on a lower half arc of the rotating path of the roller, and the picking assembly being configured to pick up a to-be-detected tablet at the first station and release the to-be-detected tablet at the second station;
a conveying assembly which is arranged below the second station, wherein the conveying assembly comprises a third station, and the conveying assembly is configured to receive the to-be-detected tablet released at the second station by the picking assembly and convey the to-be-detected tablet to the third station;
a first shooting assembly which is arranged on the rotating path of the to-be-detected tablet and faces the rotating path, wherein the first shooting assembly is configured to shoot an outward surface of the to-be-detected tablet when the to-be-detected tablet passes through the first shooting assembly;
a light reflecting assembly configured to reflect a side surface of the to-be-detected tablet; and
a second shooting assembly which is arranged above the third station in a vertical direction and faces the third station, wherein the second shooting assembly is configured to shoot an upward surface of the to-be-detected tablet when the to-be-detected tablet passes through the third station and a side surface of the to-be-detected tablet reflected by the light reflecting assembly.

2. The tablet image acquisition device according to claim 1, wherein the picking assembly comprises a plurality of clamping members, and the clamping members are configured to clamp the to-be-detected tablet at the first station and release the to-be-detected tablet at the second station.

3. The tablet image acquisition device according to claim 1, wherein the picking assembly comprises a plurality of adsorption holes, and the adsorption holes are configured to adsorb the to-be-detected tablet at the first station and release the to-be-detected tablet at the second station.

4. The tablet image acquisition device according to claim 1, wherein the first shooting assembly faces an axis of the roller in a horizontal direction.

5. The tablet image acquisition device according to claim 1, wherein the light reflecting assembly comprises at least two reflectors, and the at least two reflectors are arranged on a periphery of the third station.

6. The tablet image acquisition device according to claim 5, wherein the light reflecting assembly comprises a first reflector, a second reflector, a third reflector, and a fourth reflector;
in a conveying direction of the conveying assembly, the first reflector and the second reflector are respectively arranged on a left side and a right side of the third station and face the third station; and
in the conveying direction of the conveying assembly, the third reflector and the fourth reflector are respectively arranged on a front side and a rear side of the third station and face the third station.

7. The tablet image acquisition device according to claim 6, wherein the first reflector and the second reflector are arranged at an included angle of 60°-80° with a horizontal plane; and
the third reflector and the fourth reflector are arranged at an included angle of 40°-60° with the horizontal plane.

8. The tablet image acquisition device according to claim 6, wherein the first reflector and the second reflector are arranged at an included angle of 65°-75° with the horizontal plane; and
the third reflector and the fourth reflector are arranged at an included angle of 45°-55° with the horizontal plane.

9. The tablet image acquisition device according to claim 1, wherein the first shooting assembly further comprises a first light source, the first light source faces a shooting area of the first shooting assembly; and
the second shooting assembly further comprises a second light source, the second light source faces the third station.

10. The tablet image acquisition device according to claim 1, further comprising a control part, wherein the control part is connected to the first shooting assembly and the second shooting assembly;
a sensor is arranged at the third station, the sensor is connected to the control part, and the sensor is configured to detect whether the third station has the to-be-detected tablet; and
the control part is configured to control the first shooting assembly to shoot, and control the second shooting assembly to shoot based on a detection signal of the sensor.
